(19) United States
(12) Patent Application Publication
(10) Pub. No.: US 2004/0249034 A1
(43) Pub. Date: Dec. 9, 2004

(54) Aqueous copolymer dispersions, process for preparing them, and compositions comprising them for coatings

(76) Inventor: Christian Meiners, Gauting (DE)

Correspondence Address: CONNOLLY BOVE LODGE & HUTZ, LLP, P O BOX 2207, WILMINGTON, DE, 19899, US

(21) Appl. No.: 10/852,408

(22) Filed: May 24, 2004

(30) Foreign Application Priority Data
May 28, 2003 (DE) DE 103 24 230.9

(51) Int. Cl. C08L 1/00

(52) U.S. Cl. 524/261; 524/700; 524/556

(57) ABSTRACT

Aqueous copolymer dispersions, process for preparing them, and compositions comprising them for coatings

The present invention provides aqueous copolymer dispersions obtainable by aqueous emulsion polymerization at least of monomers a) and b) and by subsequent addition of at least one cycloalkylepoxysilane to the resulting copolymer emulsion, monomer a) being an ester of α,β-monoethylenically unsaturated carboxylic acids containing 3 to 6 carbon atoms and alkanols containing 1 to 18 carbon atoms and, if desired, a vinylaromatic compound, or a mixture of these monomers, and monomer b) being a monobasic or polybasic α,β-monoethylenically unsaturated acid and/or anhydride thereof.

The copolymer dispersions of the invention are suitable for producing coatings which are distinguished by increased tensile stress after the coating has been stretched.

### DESCRIPTION

Aqueous copolymer dispersions, process for preparing them, and compositions comprising them for coatings

The present invention relates to aqueous copolymer dispersions, to processes for their preparation, and to their use in coating materials.

For producing coatings it is common to use copolymers which are crosslinked through the use of functional monomers. Where elastic coatings or films are to be produced, their elastic properties are characterized by their extension and elasticity moduli. The extension/elasticity moduli of the polymers can be adjusted over a wide range by varying the amount of crosslinker.

It is known to prepare copolymers by emulsion polymerization. Crosslinkers used in that case are either biolefinically or oligoolefinically unsaturated monomers, such as hexanediol dimethacrylate, for example, or functional monomers or metal complexes which generally lead to crosslinking only in the course of film formation. Suitable metal complexes can be derived from transition metals from group 4A of the periodic table, such as zirconium (P. J. Moles, Polym. Paint Colour J. 1988, 178, page 154).

Crosslinkers containing two or more ethylenically unsaturated groups lead to more or less homogeneous crosslinking within the dispersion particles, while adjacent particles are crosslinked physically only by interlooping of polymer chain ends.

Also known, furthermore, are reactive crosslinking systems, in which in addition to crosslinking of the polymer chains in the polymer particles there is also an interparticulate crosslinking reaction of adjacent polymer particles in the course of film formation. Typical reactive crosslinker monomers which are incorporated as functional units in the copolymer are N-methylolacrylamide (NMAA) or olefinically unsaturated silanes and epoxides, such as vinyltrimethoxysilane or glycidyl methacrylate.

Aqueous copolymer dispersions in which monoethylenically unsaturated crosslinking silanes are copolymerized are known from DE 198 58 851 A1. Preferred silanes used are vinyltrimethoxysilane or silanes containing epoxide groups, such as the glycidyl group. Coatings and films based on such copolymer dispersions feature increased elasticity.

From DE 43 29 089 A1 it is known to add epoxysilanes during the polymerization reaction, glycidyloxypropyltrimethoxysilane for example. Dispersions of this kind are used primarily in the architectural preservation sector and are distinguished by improved wet-adhesion tensile strength when used in tile adhesives and also by improved pigment-binding capacity in paints.

Also known is the subsequent addition of epoxysilanes to modify the existing copolymer. Thus EP 0 214 696 A1 deals with the subsequent addition of 3-glycidyloxypropyltrimethoxysilane to a styrene/butyl acrylate/acrylic acid copolymer. The subsequent modification with epoxysilanes raises the wet tensile stress of such adhesives, based on a high styrene fraction, on ceramic material.

U.S. Pat. No. 4,077,932 and U.S. Pat. No. 4,032,487 deal with aqueous adhesive compositions based on copolymers in which nitrogen-containing monomers, such as dimethylaminomethyl methacrylate, for example, are copolymerized. Modification by subsequent addition of epoxysilanes, such as of glycidyloxypropyltrimethoxysilane, for example, raises the resistance to moisture and improves the tensile stress of the films. The presence of reactive amino groups in the copolymer, however, results in a premature reaction between the polymer and the epoxysilane during the storage of the adhesive composition.

Storage-stable dispersions can be obtained according to U.S. Pat. No. 6,127,462 by modifying carboxyl-containing polymers with epoxysilanes, 2-(3,4-epoxycyclohexyl)ethyltriethoxysilane for example, and initiating the crosslinking reaction with the epoxysilane crosslinker, by adding catalyst, prior to the use of the system as a coating material. Catalysts recommended are tertiary amines or organotin compounds. Even after storage, the known compositions still have a high adhesive capacity. The known compositions, however, require the presence of catalysts, tertiary amines for example, which on prolonged storage in the presence of oxygen can lead to unwanted, colored decomposition products. If the catalytic material is added during the actual preparation of the formulation, the latter's storage stability is reduced.

It has now surprisingly been found that in coatings, particularly in elastic coatings, the breaking elongation, the tensile stress at break, and the film cohesion energy can be improved simultaneously if small amounts of cycloalkylepoxysilanes are added to aqueous copolymer dispersions.

When crosslinker systems are used in copolymer dispersions the general case is that a counteractive coupling of breaking elongation and tensile stress is observed; in other words, with increasing breaking elongation, the tensile stress becomes smaller. There are only a few examples of crosslinker systems in which the normal antagonistic coupling of breaking elongation and tensile stress is suspended, i.e., with an increased concentration of crosslinker in the copolymer, an increased tensile stress in conjunction with constant or increased breaking elongation is observed.

Surface Coatings Australia 1995, 32 (5), page 18 discloses the crosslinking of dispersion polymers by polyvalent metal ions. As a result of the crosslinking there is a synergetic increase in the tensile stress of the films, with the breaking elongation of the polymers remaining approximately constant.

Proc. Int. Conf. Org. Coat.: Waterborne, High Solids, Powder Coat., 24^{th} (1998), 503-521 describes heterogeneous polymers which are produced by swelling a soft emulsion polymer with a second monomer feed and then continuing the polymerization. The second monomer feed leads to the formation of small, hard domains surrounded by soft matrix in the polymer particles, which following film formation can be visualized by transmission electron microscopy. The corresponding polymer films exhibit increased breaking elongation and tensile stress values.

The present invention provides aqueous copolymer dispersions obtainable by free-radical polymerization at least of monomers a) and b) and by subsequent addition of at least one cycloalkylepoxysilane to the resulting copolymer emulsion, monomer a) being an ester of α,β-monoethylenically unsaturated carboxylic acids containing 3 to 6 carbon atoms and alkanols containing 1 to 18 carbon atoms and, if desired, a vinylaromatic compound, or a mixture of these monomers, and monomer b) being a monobasic or polybasic α,β-monoethylenically unsaturated acid and/or anhydride thereof.

Preference is given to aqueous copolymer dispersions which in addition to monomers a) and b) are also derived at least from one of the monomers c), d), e) and/or f), monomer c) being a diethylenically or oligoethylenically unsaturated crosslinking monomer or a mixture of these monomers, monomer d) being an α,β-monoethylenically unsaturated carboxamide containing 3 to 8 carbon atoms, or a mixture of these monomers, monomer e) being a reactive crosslinker monomer selected from a combination of at least one ethylenically unsaturated silane with at least one ethylenically unsaturated monomer containing an oxirane group, or a mixture of these monomers, and monomer f) being another kind of copolymerizable ethylenically unsaturated monomer or a mixture of these monomers, with the exception of a nitrogen-containing monomer which is reactive with epoxy groups.

In a further preferred embodiment the invention provides the above-defined aqueous copolymer dispersions having a solids content of 20-65% by weight, the copolymer being derived from 40 to 99.8% by weight of monomer a) or mixtures thereof, from 0.1 to 10% by weight of monomer b) or mixtures thereof, from 0 to 10% by weight of monomer c) or mixtures thereof, from 0 to 5% by weight of monomer d) or mixtures thereof, from 0 to 5% by weight of monomer e) or mixtures thereof, and from 0 to 30% by weight of monomer f) or mixtures thereof, the amounts of monomer being based on the total amount of monomer employed.

A further preferred embodiment of the present invention provides the above-defined aqueous copolymer dispersions where the weight fractions of the monomers a) and b) are chosen such that a copolymer synthesized only from these monomers would have a glass transition temperature in the range between −50 to 120° C., preferably between −50 and 15° C.

The cycloalkylepoxysilane used in accordance with the invention is preferably a compound of the general formula (I)

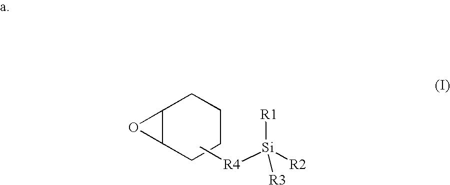

where R¹, R², and R³ are linear or branched alkoxy radicals with the oxygen atom bonding to the silicon atom and/or are alkyl radicals having 1-10 carbon atoms and R⁴ is a linear or branched alkylene radical having 1-10 carbon atoms.

The aqueous copolymer dispersions of the invention preferably comprise one or more UV initiators B) and/or one or more emulsifiers C), and/or one or more water-soluble copolymers D).

In another preferred embodiment the invention provides aqueous copolymer dispersions having a solids content of 20-65% by weight, obtainable by preparing a copolymer A) consisting essentially of

a) from 40 to 99.8% by weight, preferably from 65 to 85% by weight, of at least one ester of α,β-monoethylenically unsaturated carboxylic acids containing from 3 to 6 carbon atoms and alkanols containing 1 to 18 carbon atoms, and from 0 to 30% by weight of at least one vinylaromatic compound (monomers a),

b) from 0.1 to 10% by weight of at least one monobasic or polybasic α,β-monoethylenically unsaturated acid or anhydrides thereof (monomers b),

c) from 0 to 10% by weight, preferably 0-0.5% by weight, of at least one diethylenically or oligoethylenically unsaturated crosslinking monomer (monomers c),

d) from 0 to 5% by weight of at least one α,β-monoethylenically unsaturated carboxamide which contains 3 to 8 carbon atoms and may be substituted once or twice on the nitrogen by alkylene groups containing up to 5 carbon atoms, alkyl sulfates, alkylsulfonates, alkyl phosphates, alkyl ethers or alkyl ether sulfates or alkyl ether phosphates (monomers d),

e) from 0 to 5%, preferably from 0 to 2%, by weight of reactive crosslinker monomers selected from a combination of at least one ethylenically unsaturated silane with at least one ethylenically unsaturated monomer containing an oxirane group (monomers e),

f) from 0 to 30% by weight of at least one other kind of copolymerizable ethylenically unsaturated monomer (monomers f), with the exception of nitrogen-containing monomers which are reactive with epoxy groups,

the weight fractions being based on the total weight of monomers, and the weight fractions of the monomers a) and b) being chosen within the limits described such that a copolymer synthesized only from these monomers would have a glass transition temperature in the range between −50 and 15° C.;

by polymerizing the monomers a) to f) in water, and subsequently adding to the resultant aqueous copolymer dispersion one or more functional cyclohexylepoxysilanes of the general formula (I)

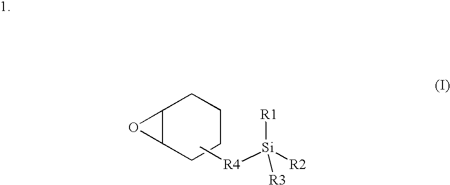

1.

where R¹, R², and R³ are linear or branched alkoxy radicals with the oxygen atom bonding to the silicon atom and/or are alkyl radicals having 1-10 carbon atoms and R⁴ is a linear or branched alkylene radical having 1 -10 carbon atoms, at temperatures between 25 and 90° C.;

and subsequently adding, if desired, one or more UV initiators B) in an amount of from 0 to 5% by weight, preferably from 0.05 to 0.5% by weight, based on the copolymer A);

if desired, one or more emulsifiers C), in an amount of from 0 to 10% by weight, based on the copolymer A); and

if desired, one or more water-soluble copolymers D), in an amount of from 0 to 4% by weight, based on the copolymer A), to the aqueous copolymer dispersion.

It has surprisingly been found the even when very small amounts of cycloalkylepoxysilanes are added, preferably cyclohexylepoxysilanes of the general formula (I), to aqueous copolymer dispersions a sharply increased fracture energy in coatings is observed. This is especially true for elastic coatings where the copolymer A) has a low glass transition temperature of −50 to +15° C. The amount of cycloalkylepoxysilane added is only very small and is typically up to is 1% by weight, based on the aqueous dispersion of the copolymer A).

It is preferred to add amounts of cycloalkylepoxysilanes of up to 0.5% by weight, in particular up to 0.25% by weight, based on the aqueous dispersion of the copolymer A).

The minimum amount of the cycloalkylepoxysilanes is 0.05% by weight, based on the aqueous dispersion of the copolymer A).

In the general formula (I) R¹, R², and R³ each independently of one another are preferably —OCH₃ or —OC₂H₅ and R⁴ is preferably —C₂H₄—.

With these small amounts added, surprisingly, increases in the fracture energies by up to about 84%, based on the initial value, have been measured. The coatings do not in this case exhibit reduced breaking elongation values.

The synergetic increase in the tensile stress and breaking elongation signifies an improvement in the performance properties of the coatings produced with the copolymer dispersions of the invention. The resultant increase in the energy required for film cracking produces improved crack bridging for a given energy, such as occurs, for example, when a painted house facade is subject to crack widening. A substantial reduction in the breaking elongation in favor of increased tensile stress has a disadvantageous consequence here, since in general the breaking elongation is directly proportional to the crack-bridging capacity. The cohesion energy of polymer films is proportional to the area under the tensile stress/breaking elongation curve and can be determined experimentally in breaking elongation tests.

The cycloalkylepoxysilanes are added to the aqueous copolymer dispersion A). In other words, they are added after the actual copolymerization of the monomers a) and b), together where appropriate with the monomers c) to f), to the copolymer A). Since only small amounts of cycloalkylepoxysilanes are sufficient as afteradditions, the aqueous copolymer dispersions of the invention can be produced at a very favorable cost.

In one preferred embodiment the copolymers used in the aqueous copolymer dispersion of the invention are copolymers having a low glass transition temperature, in a range from −50 to +15° C., as a result of which it is possible to do without the use of curing catalysts for the cycloalkylepoxysilanes.

If desired it is also possible to add UV initiators B), emulsifiers C), and water-soluble copolymers D) as an after addition to the aqueous copolymer dispersion.

The glass transition temperatures of the copolymers are determined by means of DSC (Differential Scanning Calorimetry, 20° C./min, midpoint); the monomer composition of the copolymers characterized by the glass transition temperature is determined by the Fox equation (T. G. Fox, Bull. Am. Phys. Soc. (Ser. II) 1956, 1, 123), with account being taken of the glass transition temperatures determined by DSC for the individual monomer homopolymers (as known, for example, from Emulsion Polymerization and Emulsion Polymers, John Wiley, Chichester 1997, page 624).

Additionally, copolymers which comprise a reactive crosslinker system composed of at least one ethylenically unsaturated silane, vinyltriethoxysilane for example, and at least one ethylenically unsaturated oxirane derivative, glycidyl methacrylate for example, (monomers e) likewise exhibit the inventive synergetic correlation between tensile stress and breaking elongation in coatings after they have been formulated with the cycloalkylepoxysilanes.

The copolymer A) is composed of the monomers a) and b) and where appropriate the monomers c) to f) may in each case be copolymerized.

The monomers a) are preferably esters of (meth)acrylic acid. In the text below, (meth)acrylic acid refers to both acrylic acid and methacrylic acid, and (meth)acrylate refers to esters of acrylic and methacrylic acid.

Preferred vinylaromatic compounds are styrene, methylstyrene, ethylstyrene, dimethylstyrene, diethylstyrene, and trimethylstyrene. Particular preference is given here to styrene.

As monomers b) it is preferred to use (meth)acrylic acid, itaconic acid, fumaric acid, and maleic acid, and also their anhydrides.

The monoamides and monoesters of ethylenically unsaturated dicarboxylic acids are also suitable as monomers b).

Suitable crosslinker monomers c) include, in particular, difunctional or oligofunctional (meth)acrylic esters, such as 1,6-hexanediol di(meth)acrylate, 1,3- and 1,4-butanediol di(meth)acrylate, and trimethylolpropane tri(meth)acrylate. Preference is given to amounts between 0-0.5% by weight of these monomers, based on the total weight of the monomers.

Suitable monomers d) are, in particular, (meth)acrylamide and also 2-acrylamido-2-methylprepanesulfonic acid and its salts.

Suitable monomers e) include ethylenically unsaturated silanes having at least one ethylenically unsaturated radical in combination with at least one ethylenically unsaturated monomer containing oxirane groups. A combination of this kind is also referred to as a reactive crosslinking system.

Particular preference is given here to the use of copolymerizable silanes of the general formula CH₂═CH—Si(OX)₃, where X is hydrogen, an acyl group and/or an alkyl group having not more than 10 carbon atoms. Examples of such silanes are vinyltrimethoxysilane and vinyltriethoxysilane.

Further preferred silanes are those of the general formula CH₂═CZ—COO—Y—Si(OX)₃, where Z is hydrogen or a methyl or ethyl groups, Y is a linear or branched alkylene chain having 2 to 6 carbon atoms, and X is hydrogen, an acyl group and/or an alkyl group having not more than 10 carbon atoms. One example of this monomer group is γ-methacryloyloxypropyltriethoxysilane. Suitable ethylenically unsaturated oxirane derivatives include preferably glycidyl methacrylate and glycidyl acrylate.

As monomers f) of other kinds use is made, for example, of copolymerizable emulsifiers and costabilizers such as poly(alkoxylate) (meth)acrylate phosphates or poly(alkoxylate) (meth)acrylate alcohols or ethers such as Plex® 6850-0, 2-(2-methylpropenoato)ethylsulfonate or 2-(2-methylpropenoato)ethyl sulfate, vinylsulfonate, and also functional monomers such as (meth)acrylates with a fluorinated alkyl radical.

Suitable components B) include benzophenone, acetophenone and, in particular, benzophenone derivatives such as 1-hydroxycyclohexyl phenyl ketone and, additionally, 4-methylbenzophenone and 2,4,6-trimethylbenzophenone. Advantageously use is also made of phosphine oxide derivatives, such as 2,4,6-trimethylbenzoyidiphenylphosphine oxide, alone or in blends with other UV initiators.

Suitable photoinitiators can also be used together with light stabilizers. Component B) is incorporated by stirring into the aqueous copolymer dispersion containing at least one copolymer A). In component B) it is possible for auxiliaries to be present which maintain the photoinitiator in the liquid aggregate state, such as solvents or crystallization inhibitors, for example. From the performance standpoint it is particularly advantageous if component B) is in liquid form, since it is then easier to incorporate into the copolymer dispersion. Component B) can be introduced into the copolymer dispersion of the invention or, alternatively, directly into the coating produced from the copolymer dispersion of the invention.

As emulsifiers C) it is possible to add, subsequently, those emulsifiers which also find use in emulsion polymerization. Examples of nonionic emulsifiers used include fatty alcohol polyalkoxylate ethers such as ethoxylation products of lauryl alcohol, oleyl alcohol or stearyl alcohol, and also coconut fatty alcohol, ethoxylated polypropylene oxide, and polyethoxylated or oligoethoxylated alkylphenols.

Examples of ionic emulsifiers which can be used include alkyl-, aryl-, and alkylaryl-sulfonates and -phosphonates, alkyl, aryl, and alkylaryl sulfates and phosphates, or substances containing other anionic or cationic end groups. It is also possible for oligoalkylene or polyalkylene oxide units to be inserted between the ionic polar head group and the a polar unit of the emulsifier.

Typical ionic emulsifiers which may find use in dispersions of the invention are, for example, sodium lauryl sulfate, sodium lauryl diglycol and -triglycol ether sulfate, sodium undecyl heptaglycol ether sulfate, tri(sec-butyl)phenyl heptaglycol ether sulfate, sodium dodecylbenzenesulfonate, and, preferably the alkali metal salts or ammonium salts of fatty alcohol polyglycol ether sulfosuccinates such as Aerosol® A 102 from Cytec or Disponil® SUS 87 Spezial IS from Cognis.

As water-soluble copolymers D) it is preferred to add, subsequently, styrene-maleic anhydride copolymers having a molecular weight of from 1000 to 4000 g/mol, which have been partly or fully neutralized with ammonium hydroxide or alkali metal hydroxides. If desired it is also possible to use modified styrene-maleic anhydride copolymers (SMA® resins) and their partial esters. The SMA® resins, however, are not to contain any amino groups which are reactive with the cyclohexylepoxysilanes. The modification of the SMA® resin may in this case also take place in situ.

The copolymers A) are obtainable by the methods, known to the skilled worker, of free-radical bulk, solution, suspension, and emulsion polymerization, with emulsion polymerization being the preferred preparation process.

Accordingly, the copolymer A) is preferably prepared by emulsion polymerization of the monomers a) and b) and also, if desired, c) to f) in an aqueous medium in the presence of radical-forming initiators and emulsifiers and, if desired, protective colloids, molecular weight regulators and/or further auxiliaries.

Suitable protective colloids in the emulsion polymerization are, in particular, carboxymethylcelluloses having a low molecular weight, such as the commercially available product Blanose© 7M, Blanose® 7UL, and Blanose® TEL from Clariant GmbH and also Ambergum® 3021 from Hercules.

If desired, the carboxymethylcellulose is also modified with additional radicals such as with hydroxyalkyl or alkyl groups. If needed, it is also possible to use alkyloxyalkyl-modified carboxymethylcelluloses.

The polymerization preferably takes place with metered addition of a monomer emulsion, although the copolymer can also be prepared by the batch, monomer feed or power feed technique. In the case of the latter the monomers, as such or in monomer emulsion, are metered in with a gradient in the monomer composition.

If desired it is possible to meter in two or more different monomer emulsions and hence also to produce morphologically heterogeneous copolymers.

All or some of the protective colloid or colloids can be included in the initial charge to the reactor or else metered in with the monomer emulsion or with the monomers.

The emulsion polymerization is initiated using water-soluble and/or oil-soluble initiators. The emulsion polymerization can be initiated and maintained by thermal decomposition of the initiator or by redox polymerization. In the latter case the reaction can even be carried out at temperatures below room temperature or at room temperature.

Normally the emulsion polymerization is carried out at reactor temperatures between 50 and 85° C.

Examples of suitable initiators include hydrogen peroxide, potassium, sodium or ammonium peroxodisulfate, t-butyl hydroperoxide, lauryl hydroperoxide, dibenzoyl peroxide, and other organic peroxides. Alternatively the polymerization can also be conducted in the presence of, additionally, one or more reducing substances such as sodium metabisulfite, Rongalit®, ascorbic acid or glucose (redox polymerization). In the case of redox polymerization it is preferred to add catalytically active metal salts such as iron(III) chloride in order to accelerate the formation of the radicals.

To control the molecular weight it is possible during the emulsion polymerization to add regulators, such as mercaptans; especially n-dodecyl mercaptan, thiophenol or alcohols. Usual amounts for addition of the regulator range between 0.05 and 0.3% by weight, based on the total weight of the copolymer.

Normally the dispersions of the invention are adjusted to a pH of from 3 to 10 using one or more bases. pH adjustment may also take place by neutralization of the monomer emulsion and/or initial charge with bases prior to the polymerization. The pH of the initial charge and/or monomer emulsion is preferably adjusted to a value >=2.5. With particular preference the pH of the initial charge is >=2.5 and the pH of the monomer emulsion is >=4. With particular preference the pH range of the initial charge is adjusted to pH >=2.5 and <=7 and that of the monomer emulsion to >=4 and <=7.

Alternatively, when the monomer feed technique is employed, the pH of the monomer feed can be adjusted by metering of the (partly) neutralized (meth)acrylic acid in aqueous solution or suspension.

By means of these measures the formation of coagulum during the emulsion polymerization is suppressed; moreover, at a pH range between 4 and 7, oxirane groups and alkoxysilane groups present in the emulsion polymer dispersion are more stable than in an acidic or alkaline medium. As bases for pH adjustment it is preferred to use ammonia solutions, alkali metal hydroxide and/or alkali earth metal hydroxide solutions, and sodium carbonate solutions. As alternatives to these it is also possible to use other buffer solutions or bases.

In addition it is also possible to add to the copolymer dispersions of the invention coalescers, such as white spirit, Texanol, butyl diglycol, plasticizers, such as dimethyl phthalate and dibutyl phthalate, and thickeners based on polyacrylates and/or polyurethanes. Examples of suitable thickeners are Borchigel® L 75 N from Borchers, Tafigel® PUR 40 from Münzing-Chemie, DSX® 1550 from Cognis.

Preservatives, defoamers, wetting agents, UV stabilizers, corrosion inhibitors and anticorrosion pigments, inorganic silica colloid dispersions, fillers, pigments, and other additions known to the skilled worker for the preparation of creating compositions, may likewise be added.

The aqueous copolymer dispersions of the invention are particularly suitable for use in elastic masonry paints and roof coatings, sealants and grouts, binders for leather fibers, and in adhesives. The formulations are distinguished by very good resilience after the coatings have been stretched.

The present invention is described in more detail below with reference to working examples, though without being restrictive as a result.

Determination of the Breaking Elongation and Tensile Stress

Films of the test coatings were drawn down onto a polyethylene film using a 400 μm box-type coating bar and stored at 23° C. and a relative humidity of 50% for 7 days. Then, using a punch, 6 specimens per coating, with dimensions of 110*15 mm, were isolated and the thickness of the coating test specimens was determined using a film thickness measuring instrument from Fischer, the Deltascope, and recorded. The films were then clamped into an Instron model 4302 tensile testing machine with a 100 N force transducer and commercially customary PC control. The free length of film between the clamping jaws was 60 mm. Stretching was then carried out at a pulling speed of 200 mm/min until the film broke. The PC program records the (breaking) elongation and the tensile stress up to the point of film breakage, and also the Young's modulus and the fracture energy absorption. For these data to be determined it is necessary to enter the dry film thickness in the PC program prior to the test.

Determination of the Particle Size

The particle size of the polymer dispersions was determined by means of photon correlation spectroscopy with a scattering angle of 90° as the weight mean (dw).

### EXAMPLE 1

Preparation of an Aqueous Copolymer Dispersion

500 g of n-butyl acrylate, 200 g of 2-ethylhexyl acrylate, 270 g of styrene and 20 g of methacrylic acid (monomer mixture) were emulsified into a solution of 64.4 g of Genapol® LRO containing 28% by weight of sodium lauryl alcohol diglycol ether sulfate as active substance in water (from Clariant), and 954 g of water and the emulsion was subjected to shearing for 10 minutes using a dissolver at 1000 revolutions per minute (rpm).

202 g of the monomer emulsion were weighed off and admixed with a solution of 0.5 g of sodium peroxodisulfate in 10 g of water. This initial charge was then heated to 80° C. with stirring (120 rpm, anchor stirrer) in a glass reactor and after a waiting time of 10 minutes the remaining monomer emulsion was metered in over the course of 2.5 h through a dropping funnel. In parallel with the monomer emulsion a solution of 4.3 g of sodium peroxodisulfate and 90 g of water were added to the batch through a dropping funnel. After the end of the feed heating was continued at 80° C for 1 h and then, on cooling, at about 70° C., the batch was adjusted to a pH of 7 using 12.5% strength by weight of aqueous ammonia. Finally, at an internal temperature of 25° C., 7 g of Irgacure 500 from Ciba Specialty Chemicals were stirred into the dispersion.

This gave a copolymer dispersion having a solids content of about 48% by weight. The particle size dw was 138 nm.

### EXAMPLE 2

The copolymer dispersion used was a UV-crosslinking acrylate dispersion for elastic coatings, containing about 55% by weight of Mowilith® LDM 7900 from Celanese Emulsions GmbH.

### EXAMPLE 3

Preparation of the Aqueous Copolymers of the Invention Containing Cyclohexylepoxysilane

The cyclohexylepoxysilane [Coatosil® 1770 (OSi, corresponding to β-(3,4-epoxycyclohexyl)ethyltriethoxysilane)] was incorporated into the copolymer dispersions of Example 1 and 2 using a mechanical stirrer and was distributed uniformly in the dispersion by stirring for 10 minutes.

TABLE 1

| | | % by weight of β-(3,4- |
|---|---|---|
| | | epoxycyclohexyl)ethyl triethoxysilane, |
| Example | Dispersion | based on the aqueous dispersion |
| 3a (comparative) | Example 1 | — |
| 3b | Example 1 | 0.1 |
| 3c (comparative) | Example 2 | — |
| 3d | Example 2 | 0.1 |

### EXAMPLE 4

Production of Elastic Masonry Coatings

5 g of a 10% strength solution of Calgon® N from BK Ladenburg, 1.4 g of Coatex® P 90 from Dimed and 2 g of Foammaster® 111 FA from Cognis were added in succession with stirring to 100 g of water. Then 80 g of titanium dioxide (Kronos® L 2310, Kronos Titan) and 380 g of calcium carbonate (Durcal® 2, Omya) were added in succession and the components were stirred using a dissolver at 5000 rpm for 15 minutes. Subsequently 485 g (Example 3a, b) or 422 g (Example 3c, d) of polymer dispersion were added at 500 rpm and also 1 g of 25% strength aqueous ammonia was added and the mixture was stirred for 5 minutes. Finally 2 g of Mergal® K9 from Troy, 2 g of butyl diglycol, 10 g of propylene glycol, 5 g of white spirit (boiling range 135-180° C.) and, to finish, a solution of 7.5 g of Coatex® BR 100 from Dimed and 23.2 g of water were added. Stirring was subsequently continued for about 5 minutes more.

TABLE 2

| | | Additive [% by weight, based |
|---|---|---|
| Example | Dispersion | on the aqueous dispersion] |
| 4a (comparative) | Example 1 | — |
| 4b | Example 1 | 0.1 |
| 4c (comparative) | Example 2 | — |
| 4d | Example 2 | 0.1 |

### EXAMPLE 5

Determination of the Breaking Elongation and Tensile Stress of Coatings

TABLE 3

| | Tensile | | | | |
|---|---|---|---|---|---|
| | stress | Breaking | | | |
| | at fracture | elongation at | | Fracture | |
| Coating | [MPa] | fracture | Δ | energy [J] | Δ |
| 4a (comparative) | 1.02 | 360 | | 0.43 | |
| 4b | 1.04 | 524 | +45.6 | 0.79 | 83.7 |
| 4c (comparative) | 1.36 | 139 | | 0.22 | |
| 4d | 1.39 | 161 | +15.8 | 0.27 | 22.7 |

As shown by a comparison of Examples 4a with 4b and 4c with 4d, the coatings 4b and 4d, which are based on the copolymers of the invention containing cyclohexylepoxysilane, are distinguished by an increased tensile stress and correspondingly increased resilience after the coating has been stretched.

What is claimed is:

1. An aqueous copolymer dispersion obtainable by free-radical polymerization at least of monomers a) and b) and by subsequent addition of at least one cycloalkylepoxysilane to the resulting copolymer emulsion, monomer a) being an ester of α,β-monoethylenically unsaturated carboxylic acids containing 3 to 6 carbon atoms and alkanols containing 1 to 18 carbon atoms and, if desired, a vinylaromatic compound, or a mixture of these monomers, and monomer b) being a monobasic or polybasic α,β-monoethylenically unsaturated acid and/or anhydride thereof.

2. The aqueous copolymer dispersion as claimed in claim 1, wherein in addition to monomers a) and b) use is also made of at least one of the monomers c), d), e) and/or f), monomer c) being a diethylenically or oligoethylenically unsaturated crosslinking monomer or a mixture of these monomers, monomer d) being an α,β-monoethylenically unsaturated carboxamide containing 3 to 8 carbon atoms, or a mixture of these monomers, monomer e) being a reactive crosslinker monomer selected from a combination of at least one ethylenically unsaturated silane with at least one ethylenically unsaturated monomer containing an oxirane group, or a mixture of these monomers, and monomer f) being another kind of copolymerizable ethylenically unsaturated monomer or a mixture of these monomers, with the exception of a nitrogen-containing monomer which is reactive with epoxy groups.

3. The aqueous copolymer dispersion as claimed in claim 1, which has a solids content of 20-65% by weight, and wherein the copolymer is derived from 40 to 99.8% by weight of monomer a) or mixtures thereof, from 0.1 to 10% by weight of monomer b) or mixtures thereof, from 0 to 10% by weight of monomer c) or mixtures thereof, from 0 to 5% by weight of monomer d) or mixtures thereof, from 0 to 5% by weight of monomer e) or mixtures thereof, and from 0 to 30% by weight of monomer f) or mixtures thereof, the amounts of monomer being based on the total amount of monomer employed.

4. The aqueous copolymer dispersion as claimed in claim 1, wherein within the limits described the weight fractions of the monomers a) and b) are chosen such that a copolymer synthesized only from these monomers would have a glass transition temperature in the range between −50 to 120° C., preferably between −50 and 15° C.

5. The aqueous copolymer dispersion as claimed in claim 1, wherein the cycloalkylepoxysilane is a compound of the general formula (I) 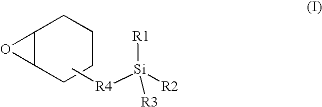
where R¹, R², and R³ are linear or branched alkoxy radicals with the oxygen atom bonding to the silicon atom and/or are alkyl radicals having 1-10 carbon atoms and R⁴ is a linear or branched alkylene radical having 1-10 carbon atoms.

6. The aqueous copolymer dispersion as claimed in claim 1, comprising one or more UV initiators B) and/or one or more emulsifiers C), and/or one or more water-soluble copolymers D).

7. The aqueous copolymer dispersion as claimed in claim 1, which has a solids content of 20-65% by weight and is obtainable by preparing a copolymer A) consisting essentially of
a) from 40 to 99.8% by weight, preferably from 65 to 85% by weight, of at least one ester of α,β-monoethylenically unsaturated carboxylic acids containing from 3 to 6 carbon atoms and alkanols containing 1 to 18 carbon atoms, and from 0 to 30% by weight of at least one vinylaromatic compound (monomers a),
b) from 0.1 to 10% by weight of at least one monobasic or polybasic α,β-monoethylenically unsaturated acid or anhydrides thereof (monomers b),
c) from 0 to 10% by weight, preferably 0-0.5% by weight, of at least one diethylenically or oligoethylenically unsaturated crosslinking monomer (monomers c),
d) from 0 to 5% by weight of at least one α,β-monoethylenically unsaturated carboxamide which contains 3 to 8 carbon atoms and may be substituted once or twice on the nitrogen by alkylene groups containing up to 5 carbon atoms, alkyl sulfates, alkylsulfonates, alkyl phosphates, alkyl ethers or alkyl ether sulfates or alkyl ether phosphates (monomers d),
e) from 0 to 5%, preferably from 0 to 2%, by weight of reactive crosslinker monomers selected from a combination of at least one ethylenically unsaturated silane with at least one ethylenically unsaturated monomer containing an oxirane group (monomers e),
f) from 0 to 30% by weight of at least one other kind of copolymerizable ethylenically unsaturated monomer (monomers f), with the exception of nitrogen-containing monomers which are reactive with epoxy groups,
the weight fractions being based on the total weight of monomers, and the weight fractions of the monomers a) and b) being chosen within the limits described such that a copolymer synthesized only from these monomers would have a glass transition temperature in the range between −50 and 15° C.; by polymerizing the monomers a) to f) in water, and subsequently adding to the resultant aqueous copolymer dispersion one or more functional cyclohexylepoxysilanes of the general formula (I) 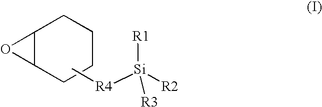
where R¹, R², and R³ are linear or branched alkoxy radicals with the oxygen atom bonding to the silicon atom and/or are alkyl radicals having 1-10 carbon atoms and R⁴ is a linear or branched alkylene radical having 1-10 carbon atoms, at temperatures between 25 and 90° C.;
and subsequently adding, if desired, one or more UV initiators B) in an amount of from 0 to 5% by weight, preferably from 0.05 to 0.5% by weight, based on the copolymer A);
if desired, one or more emulsifiers C), in an amount of from 0 to 10% by weight, based on the copolymer A); and
if desired, one or more water-soluble copolymers D), in an amount of from 0 to 4% by weight, based on the copolymer A),
to the aqueous copolymer dispersion.

8. The aqueous copolymer dispersion as claimed in claim 7, wherein the cyclohexylepoxysilane of the general formula (I) is added in an amount of up to 1% by weight, preferably of up to 0.5% by weight, in particular of up to 0.25% by weight, based on the aqueous dispersion of the copolymer A).

9. The aqueous copolymer dispersion as claimed in claim 7, wherein the radicals R¹, R², and R³ in the general formula (I) in each case independently of one another are —OCH₃ or —OC₂H₅ and the radical R⁴ is —C₂H₄—.

10. The aqueous copolymer dispersion as claimed in claim 7, wherein as esters of α,β-monoethylenically unsaturated carboxylic acids containing 3 to 6 carbon atoms and alkanols containing 1 to 18 carbon atoms esters of acrylic acid and/or methacrylic acid are used.

11. The aqueous copolymer dispersion as claimed in claim 7, wherein as vinylaromatic compound styrene is used.

12. The aqueous copolymer dispersion as claimed in claim 7, wherein as α,β-monoethylenically unsaturated carboxamide methacrylamide is used.

13. The aqueous copolymer dispersion as claimed in claim 7, wherein as monomers e) silanes of the general formula CH₂═CH—Si(OX)₃ are used where X is hydrogen, an acyl group or an alkyl group having not more than ten carbon atoms.

14. The aqueous copolymer dispersion as claimed in claim 7, wherein as monomers e) silanes of the general formula CH₂═CZ—COO—Y—Si(OX)₃ are used where Z is hydrogen or a methyl or ethyl group, Y is a linear or branched alkylene chain having 2 to 6 carbon atoms, and X is hydrogen, an acyl group or an alkyl group having not more than ten carbon atoms.

15. The aqueous copolymer dispersion as claimed in claim 7, wherein as monomers e) glycidyl methacrylate and/or glycidyl acrylate are used.

16. The aqueous copolymer dispersion as claimed in claim 7, wherein as component B) benzophenone, acetophenone, 1-hydroxycyclohexyl phenyl ketone, 4-methylbenzophenone and 2,4,6-trimethylbenzophenone are used.

17. The aqueous copolymer dispersion as claimed in claim 7, wherein as component C) nonionic and/or ionic emulsifiers are used.

18. The aqueous copolymer dispersion as claimed in claim 7, wherein as water-soluble copolymer D) styrene-maleic anhydride copolymers having a molecular weight of from 1000 to 4000 g/mol are used.

19. A process for preparing an aqueous copolymer dispersion as claimed in claim 1, which comprises subjecting the monomers a) and b) and, where appropriate, c), d), e) and/or f) as set forth in claim 2 to free-radical polymerization in aqueous medium in the presence of water-soluble radical-forming initiators, emulsifiers and/or protective colloids, regulators and/or further auxiliaries, by emulsion polymerization, and subsequently adding to the resulting aqueous copolymer dispersion one or more cycloalkylepoxysilanes, preferably functional cyclohexylepoxysilanes of the general formula (I) 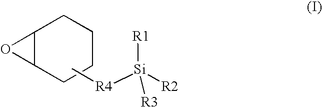
where R¹, R², and R³ are linear or branched alkoxy radicals with the oxygen atom bonding to the silicon atom and/or are alkyl radicals having 1-10 carbon atoms and R⁴ is a linear or branched alkylene radical having 1-10 carbon atoms, at temperatures between 25 and 90° C., and subsequently adding, if desired, one or more UV initiators B), if desired, one or more emulsifiers C), and, if desired, one or more water-soluble copolymers D).

20. The use of the aqueous copolymer dispersion as claimed in claim 1 for producing coatings.

21. The use as claimed in claim 20 for elastic masonry paints and elastic roof coatings.

22. The use of the aqueous copolymer dispersion as claimed in claim 1 for grouts.

23. The use of the aqueous copolymer dispersion as claimed in claim 1 as a leather fiber binder.

24. The use of the aqueous copolymer dispersion as claimed in claim 1 for adhesives.

25. A coating material comprising an aqueous copolymer dispersion as claimed in claim 1 and substantially
a) pigments,
b) fillers,
c) dispersants,
d) wetting agents,
e) UV filter substances,
f) flame retardants,
g) thickeners,
h) plasticizers, and
i) defoamers.
